(19) United States
(12) Patent Application Publication
(10) Pub. No.: US 2017/0255169 A1
(43) Pub. Date: Sep. 7, 2017

(54) WATCH TYPE TERMINAL

(71) Applicant: LG ELECTRONICS INC., Seoul (KR)

(72) Inventors: Chulbae LEE, Seoul (KR); Hyunju KIM, Seoul (KR); Sungwon SHIN, Seoul (KR); Goeun LEE, Seoul (KR)

(73) Assignee: LG ELECTRONICS INC., Seoul (KR)

(21) Appl. No.: 15/507,039

(22) PCT Filed: Jan. 22, 2015
(86) PCT No.: PCT/KR2015/000684

§ 371 Date: Feb. 27, 2017

(30) Foreign Application Priority Data
Aug. 29, 2014 (KR) 10-2014-0114562

(51) Int. Cl. G04G 21/08; G06F 3/0482; G04B 19/06; G04B 19/28; G04G 9/00; G04B 19/04

(52) U.S. Cl. CPC G04G 21/08; G04G 9/00; G04B 19/04; G04B 19/06; G04B 19/283; G06F 3/0482; G06F 3/0488

(57) ABSTRACT

A watch type terminal includes: a body formed to be fixed to a user's wrist; a display unit mounted to the body, and configured to display current time information; a memory configured to store therein a plurality of graphic images sorted from one another according to a plurality of contents for indicating the time information; and a controller configured to control the display unit to output screen information indicating the time information, the screen information including at least one graphic image selected from the plurality of graphic images based on a control command.

### TECHNICAL FIELD

The present invention relates to a watch type terminal having a display unit for outputting time information.

### BACKGROUND ART

A terminal is broadly categorized by mobility into a mobile (portable) terminal and a stationary terminal. The mobile terminal is further categorized by portability into a handheld terminal and a vehicle-mounted terminal.

In response to an increasing demand for diversified functions, the terminal has been realized in the form of a multimedia player with multiple functions such as capturing a still image or a moving image of a photographic subject, reproducing a digital audio and video compression file, playing a game, receiving a broadcast or the like. Furthermore, structural and software modifications to the mobile terminal are considered for supporting and improving functions of the mobile terminal.

Owing to such improvement, a recent mobile terminal is being evolved to have various designs, and a wrist-type mobile terminal which can be fixed to a user's body is being developed.

As demands for a watch type mobile terminal are increased, research on developing a mobile terminal satisfying a user' taste, is actively ongoing.

### DISCLOSURE OF INVENTION

### Technical Problem

Therefore, an object of the present invention is to provide a watch type terminal capable of outputting time information to which a personal design reflecting a user's taste has been applied.

### Solution to Problem

To achieve these and other advantages and in accordance with the purpose of the present invention, as embodied and broadly described herein, there is provided a watch type terminal, including: a body formed to be fixed to a user's wrist; a display unit mounted to the body, and configured to display current time information; a memory configured to store therein a plurality of graphic images sorted from one another according to a plurality of contents for indicating the time information; and a controller configured to control the display unit to output screen information indicating the time information, the screen information including at least one graphic image selected from the plurality of graphic images based on a control command.

In an embodiment, the controller may control the display unit to output an edition screen corresponding to an edition mode activated based on an edition control command applied to the display unit. And the display unit may output an edition image corresponding to a selected first content, and may change the edition image into another image based on a preset type of first touch applied to the edition image. Thus, a user can change part of a plurality of contents, by changing a current mode of the watch type terminal into an edition mode.

In an embodiment, the watch type terminal may further include a wireless communication unit configured to receive data related to a background image, from outside. The controller may control the display unit to change the time information based on the data. Thus, a user can immediately change the time information in a matching manner with external environments.

In an embodiment, the wireless communication unit may be wirelessly connected to a mobile terminal including a display unit, and the controller may control the wireless communication unit to receive data on a plurality of graphic images output to the display unit of the mobile terminal, the data corresponding to the plurality of contents. Thus, a user can change screen information in various designs using data stored in the mobile terminal, and can simply change time information using a wider display unit.

### Advantageous Effects of Invention

In the present invention, since each content of time information composed of a plurality of contents and indicating time is changed to a different form, screen information providing different aesthetic feeling while indicating the same time information can be implemented.

Further, since a user can change each of a plurality of contents individually, images matching a user's taste can be combined with each other. Thus, a watch type terminal capable of satisfying a user's taste individually can be provided.

### BRIEF DESCRIPTION OF DRAWINGS

FIG. 1 is a block diagram illustrating a mobile terminal according to one embodiment of the present invention;

FIG. 2 is a perspective view illustrating an example of a watch type terminal according to another embodiment of the present invention;

FIG. 3 is a flowchart illustrating a method of controlling screen information according to an embodiment of the present invention;

FIGS. 4A to 4C are conceptual views illustrating the control method of FIG. 3 according to various embodiments of the present invention;

FIGS. 5A to 5F are conceptual views illustrating a control method of activating an edition mode while time information is being output;

FIGS. 6A to 6C are conceptual views illustrating a control method of changing time information using a mobile terminal according to an embodiment;

FIGS. 7A to 7C are conceptual views illustrating a control method of changing time information using a mobile terminal according to another embodiment;

FIGS. 8A and 8B are conceptual views illustrating a control method of changing time information according to a mode selection;

FIGS. 9A to 9D are conceptual views illustrating a control method of adding storage information stored in a mobile terminal, to time information;

FIGS. 10A to 10D are conceptual views illustrating a control method of changing time information using external information;

FIGS. 11A to 11C are conceptual views illustrating a control method of changing part of a dial portion;

FIG. 12 is a conceptual view illustrating an edition screen of a mobile terminal for setting a display unit of a watch type terminal;

FIGS. 13A to 13F are conceptual views illustrating a control method of changing time information using received external information; and

FIGS. 14A and 14B are conceptual views illustrating a control method of changing time information, based on a touch input applied to a bezel portion.

### MODE FOR THE INVENTION

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being connected with another element, the element can be connected with the other element or intervening elements may also be present. In contrast, when an element is referred to as being directly connected with another element, there are no intervening elements present.

A singular representation may include a plural representation unless it represents a definitely different meaning from the context.

Terms such as include or has are used herein and should be understood that they are intended to indicate an existence of several components, functions or steps, disclosed in the specification, and it is also understood that greater or fewer components, functions, or steps may likewise be utilized.

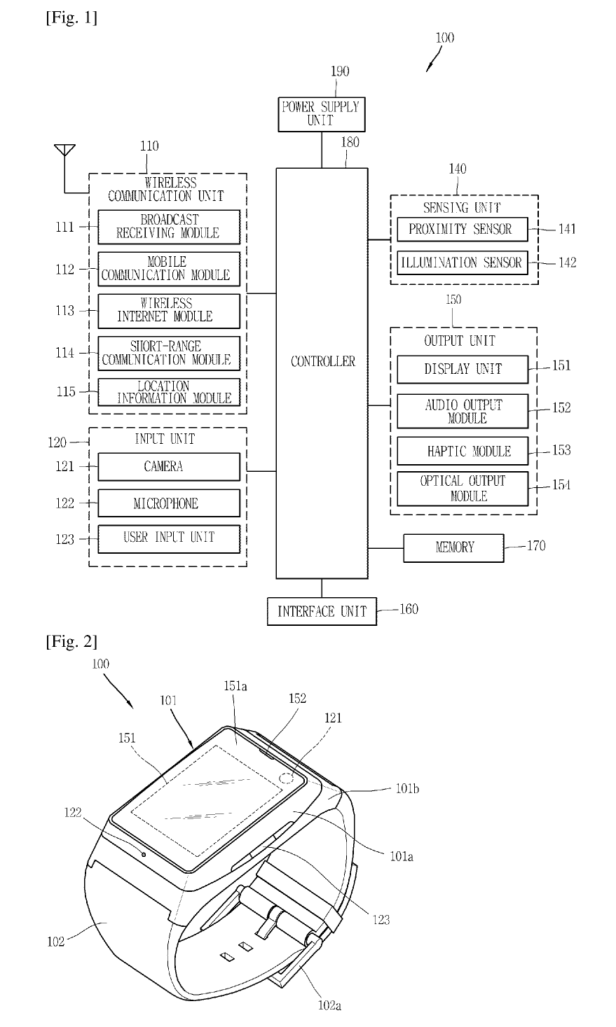

FIG. 1 is an exemplary schematic view illustrating a watch type terminal according to the present invention

As shown in FIG. 1, the watch type terminal 100 is shown to have components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

The wireless communication unit 110 typically includes one or more modules which permit communications such as wireless communications between the watch type terminal 100 and a wireless communication system, communications between the watch type terminal 100 and another mobile terminal, communications between the watch type terminal 100 and an external server. Further, the wireless communication unit 110 typically includes one or more modules which connect the watch type terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The watch type terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the watch type terminal 100 and a user, as well as function as the user input unit 123 which provides an input interface between the watch type terminal 100 and the user.

The interface unit 160 serves as an interface with various types of external devices that can be coupled to the watch type terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the watch type terminal 100 may perform assorted control functions associated with a connected external device, in response to the external device being connected to the interface unit 160.

The memory 170 is typically implemented to store data to support various functions or features of the watch type terminal 100. For instance, the memory 170 may be configured to store application programs executed in the watch type terminal 100, data or instructions for operations of the watch type terminal 100, and the like. Some of these application programs may be downloaded from an external server via wireless communication. Other application programs may be installed within the watch type terminal 100 at time of manufacturing or shipping, which is typically the case for basic functions of the watch type terminal 100 (for example, receiving a call, placing a call, receiving a message, sending a message, and the like). It is common for application programs to be stored in the memory 170, installed in the watch type terminal 100, and executed by the controller 180 to perform an operation (or function) for the watch type terminal 100.

The controller 180 typically functions to control overall operation of the watch type terminal 100, in addition to the operations associated with the application programs. The controller 180 may provide or process information or functions appropriate for a user by processing signals, data, information and the like, which are input or output by the various components, or activating application programs stored in the memory 170.

As one example, the controller 180 controls some or all of the components so as to drive application programs that have been stored in the memory 170. For driving of the application programs, the controller 180 may operate at least two of the components included in the watch type terminal 100, through a combination.

The power supply unit 190 can be configured to receive external power or provide internal power in order to supply appropriate power required for operating elements and components included in the watch type terminal 100. The power supply unit 190 includes a battery, and the battery is configured to be built-in (mountable) or chargeable.

At least some of the components may operate in cooperation with one another in order to implement an operation, control or control method of the mobile terminal according to various exemplary embodiments to be described below. The operation, control or control method of the mobile terminal may be implemented on the mobile terminal by the execution of at least one application program stored in the memory 170.

Hereinafter, the aforementioned components will be explained in more detail with reference to FIG. 1, before various embodiments are explained.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the watch type terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the watch type terminal 100 and a wireless communication system, communications between the watch type terminal 100 and another watch type terminal 100, or communications between the mobile terminal and a network where another watch type terminal 100 (or an external server) is located, via wireless area networks. One example of the wireless area networks is a wireless personal area networks.

In some embodiments, another mobile terminal (which may be configured similarly to the watch type terminal 100) may be a wearable device, for example, a smart watch, a smart glass or a head mounted display (HMD), which is able to exchange data with the mobile terminal 100 (or otherwise cooperate with the watch type terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the watch type terminal 100. As another example, the cameras 121 may be located in a stereoscopic arrangement to acquire left and right images for implementing a stereoscopic image.

The microphone 122 is generally implemented to permit audio input to the watch type terminal 100. The audio input can be processed in various manners according to a function being executed in the watch type terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the watch type terminal 100. The user input unit 123 may include one or more of a mechanical input element (for example, a key, a button located on a front and/or rear surface or a side surface of the watch type terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the watch type terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electro-magnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term proximity touch will often be referred to herein to denote the scenario in which a pointer is positioned to be proximate to the touch screen without contacting the touch screen. The term contact touch will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the watch type terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the watch type terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the watch type terminal 100. For example, the display unit 151 may display execution screen information of an application program executing at the watch type terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the watch type terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the watch type terminal 100.

An optical output module 154 can output a signal for indicating an event generation using light of a light source. Examples of events generated in the watch type terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the watch type terminal 100. For example, the interface unit 160 can receive data transmitted from an external device, receive power to transfer to elements and components within the watch type terminal 100, or transmit internal data of the watch type terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the watch type terminal 100 and may include a user identity module (UIM), a subscriber identity module (SIM), a universal subscriber identity module (USIM), and the like. In addition, the device having the identification module (also referred to herein as an identifying device) may take the form of a smart card. Accordingly, the identifying device can be connected with the terminal 100 via the interface unit 160.

When the watch type terminal 100 is connected with an external cradle, the interface unit 160 can serve as a passage to allow power from the cradle to be supplied to the watch type terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The watch type terminal 100 may also be operated in relation to a network storage device that performs the storage function of the memory 170 over a network, such as the Internet.

The controller 180 may typically control the general operations of the watch type terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the watch type terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

An accessory for protecting an appearance or assisting or extending the functions of the watch type terminal 100 can also be provided on the watch type terminal 100. As one example of an accessory, a cover or pouch for covering or accommodating at least one surface of the watch type terminal 100 may be provided. The cover or pouch may cooperate with the display unit 151 to extend the function of the watch type terminal 100. Another example of the accessory is a touch pen for assisting or extending a touch input to a touch screen.

FIG. 2 is a perspective view illustrating one example of a watch type terminal 100 in accordance with another exemplary embodiment. As illustrated in FIG. 2, the watch type terminal 100 includes a main body 101 with a display unit 151 and a band 102 connected to the main body 101 to be wearable on a wrist. In general, the watch type terminal 100 may be configured to include features that are the same or similar to that of the watch type terminal 100 of FIG. 1.

The main body 101 may include a case having a certain appearance. As illustrated, the case may include a first case 101a and a second case 101b cooperatively defining an inner space for accommodating various electronic components. Other configurations are possible. For instance, a single case may alternatively be implemented, with such a case being configured to define the inner space, thereby implementing a watch type terminal 100 with a uni-body.

The watch type terminal 100 can perform wireless communication, and an antenna for the wireless communication can be installed in the main body 101. The antenna may extend its function using the case. For example, a case including a conductive material may be electrically connected to the antenna to extend a ground area or a radiation area.

The display unit 151 is shown located at the front side of the main body 101 so that displayed information is viewable to a user. In some embodiments, the display unit 151 includes a touch sensor so that the display unit can function as a touch screen. As illustrated, window 151a is positioned on the first case 101a to form a front surface of the terminal body together with the first case 101a.

The illustrated embodiment includes an audio output module 152, a camera 121, a microphone 122, and a user input unit 123 positioned on the main body 101. When the display unit 151 is implemented as a touch screen, additional function keys may be minimized or eliminated. For example, when the touch screen is implemented, the user input unit 123 may be omitted.

The band 102 is commonly worn on the user's wrist and may be made of a flexible material for facilitating wearing of the device. As one example, the band 102 may be made of fur, rubber, silicon, synthetic resin, or the like. The band 102 may also be configured to be detachable from the main body 101. Accordingly, the band 102 may be replaceable with various types of bands according to a user's preference.

In one configuration, the band 102 may be used for extending the performance of the antenna. For example, the band may include therein a ground extending portion (not shown) electrically connected to the antenna to extend a ground area.

The band 102 may include fastener 102a. The fastener 102a may be implemented into a buckle type, a snap-fit hook structure, a Velcro type, or the like, and include a flexible section or material. The drawing illustrates an example that the fastener 102a is implemented using a buckle.

The watch type terminal 100 changes screen information output to the display unit so as to indicate a current time, based on a control command.

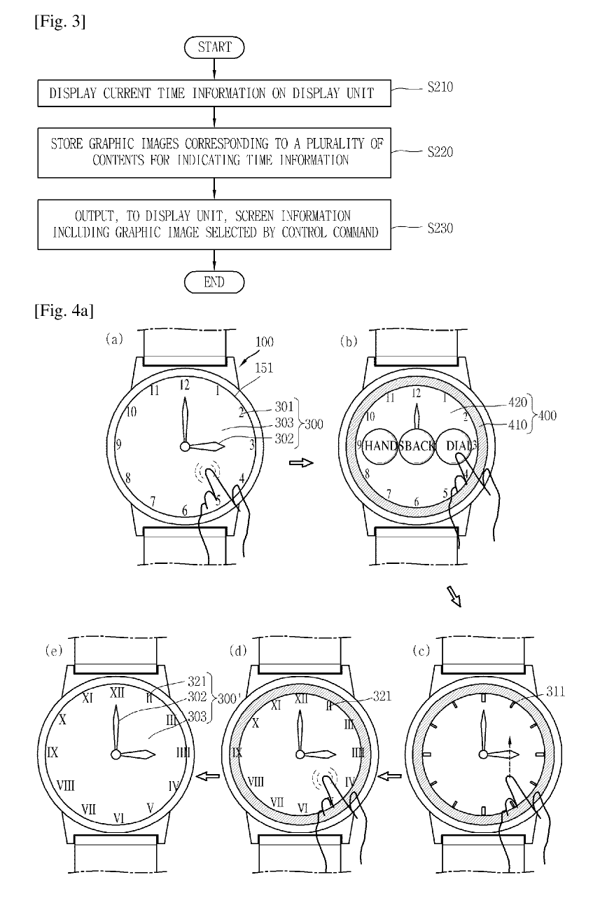

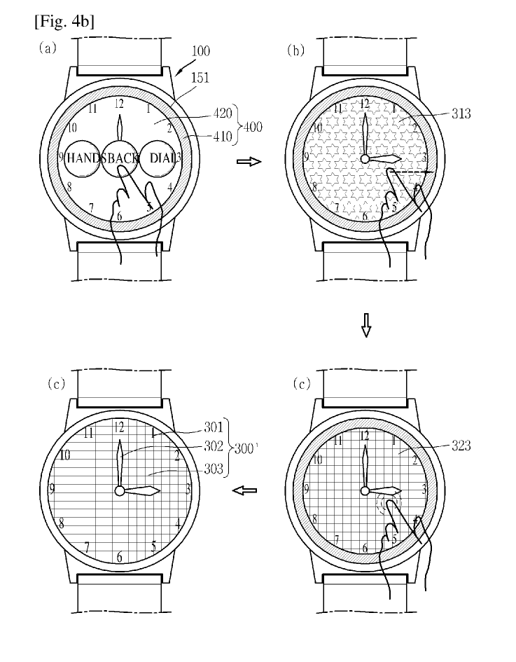

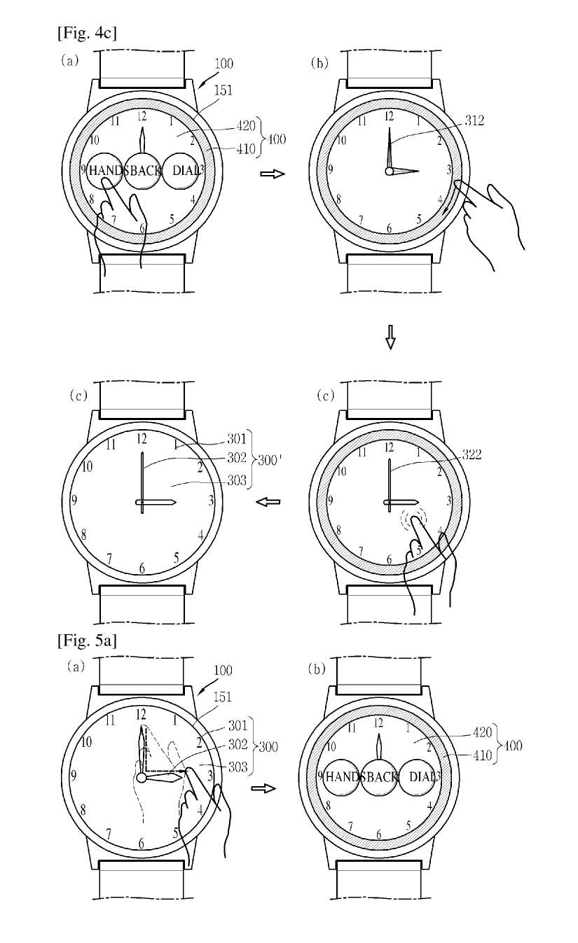

FIG. 3 is a flowchart illustrating a method of controlling screen information according to an embodiment of the present invention. FIGS. 4A to 4C are conceptual views illustrating the control method of FIG. 3 according to various embodiments of the present invention.

Referring to FIGS. 3 and 4C, the display unit 151 displays time information 300 indicating a current time (S210). The time information 300 includes a plurality of contents. For instance, the plurality of contents include a dial portion 301 having 12 dials for indicating hours, a hands-portion 302 configured to be movable among the 12 dials to indicate a current time, i.e., an hour(s) and a minute(s), and a background image 303 displayed to be overlapped with the dial portion 301 and the hands-portion 302. However, content included in the time information 300 is not limited to this. That is, new content may be added to the content included in the time information 300, or the content included in the time information 300 may be omitted based on a user's setting.

The watch type terminal 100 may change the time information 300, such that the dial portion 301 indicated by the hands-portion 302 in correspondence to a current time is changed.

The memory 170 stores therein graphic images corresponding to a plurality of contents indicating the time information (S220). That is, the memory 170 may include different types of graphic images with respect to the dial portion 301, the hands-portion 302 and the background image 303.

That is, a plurality of graphic images corresponding to a single content are formed in different shapes, but the respective graphic images are displayed on the same position on the display unit 151. Further, the graphic images implemented in different shapes have the same meaning. For instance, the dial portion 301 may be formed as Arabic numerals of 1˜12, or the Roman alphabets of 1˜12. The Arabic numerals and the Roman alphabets are set to be arranged, with being rotated to the right along an edge region of the display unit 151.

The memory 170 may store therein graphic images corresponding to a plurality of contents in an individual manner, or may store therein a combined image of graphic images corresponding to a plurality of contents.

The controller controls the display unit 151 to output screen information including a graphic image selected from the plurality of graphic images, based on a control command (S230). A control method of selecting a graphic image constituting the screen information will be explained with reference to FIG. 4A.

Referring to FIGS. 4A(a) and (b), when an edition command is applied to the watch type terminal in a state where the time information 300 has been output to the display unit 151, the controller controls the display unit 151 to output an edition screen 400.

For instance, the edition command may be a control command applied by a user. When a long touch input is applied to the display unit 151 for a preset time, the controller controls the display unit 151 to convert the time information 300 into the edition screen 400.

The edition screen 400 may include an edition menu 420, and an inactive region 410 formed to enclose the edition menu 420. The edition menu 420 may include menu icons displayed on the time information 300. That is, the hands-portion, the dial portion, and the background image are displayed on the edition menu 400 in the same manner as the time information 300. A user can distinguish the edition screen 400 from the time information 300 based on the inactive region 410, and can recognize that an edition mode is in an active state. The inactive region 410 may be formed to have a preset image, and reception of a touch input at the inactive region 410 may be allowed or restricted.

A plurality of menu icons correspond to a plurality of contents included in the time information 300. Referring to FIGS. 4A(b) and (c), when a touch input is applied to a menu icon marked with DIAL, the controller outputs a first dial image 311 having a different shape from the dial portion 301. The first dial image 311 may be composed of division points corresponding to the Arabic numerals of 1˜12.

Based on a touch input applied to the edition screen 400 including the first dial image 311, the controller controls the display unit 151 to change the first dial image 311, into a second dial image 321 having a different shape from the first dial image 311.

The controller 180 controls the display unit 151 to output screen information 300′ to which the second dial image 321 has been applied, based on a storage control command applied in a state where the second dial image 321 has been output. The storage control command may be defined as a specific type of touch input applied to the display unit 151.

The present invention can provide screen information indicating the same time information, by providing different aesthetic feeling by changing each content of time information composed of a plurality of contents, into a different form.

Further, a user can combine his or her preferred images with each other, since a plurality of contents can be changed in an individual manner. Therefore, a watch type terminal, capable of meeting (satisfying) users' various tastes individually, can be provided.

Referring to FIG. 4B, a control method of changing a background image will be explained. The display unit 151 outputs the edition screen 400 composed of the edition menu 420 including the contents, and the inactive region 410 formed to enclose the edition menu 420. A control method of outputting the edition screen 400 will be replaced by the explanations aforementioned with reference to FIG. 4A.

The controller 180 controls the display unit 151 to output a first edition background 313 on the edition menu 420, based on a touch input applied to a menu icon marked with BACK. While the edition screen 400 including the first edition background 313 is being output, the controller 180 controls the display unit 151 to change the first edition background 313 into a second edition background 323, based on a touch input applied to the display unit 151.

A touch input for outputting the second edition background 323 may be differentiated from a touch input for outputting the second dial image 321. Referring to FIGS. 4A(c) and 4B(b), a touch input for outputting the second dial image 321 may be implemented as a consecutive touch input moving to the right of the display unit 151. On the contrary, a touch input for outputting the second edition background 323 may be implemented as a consecutive touch input moving to a lower direction of the display unit 151.

Although not shown, when the touch input type is differentiated from another touch input type, the controller 180 may control the display unit 151 to provide a graphic image of a different shape based on the touch input type, irrespective of a type of a selected menu icon. For instance, when a menu icon marked with DIAL is selected, if a touch input toward a lower direction is applied, the controller 180 may control the display unit 151 to output a new edition background.

Once the storage control command is applied to the display unit 151, the controller 180 controls the display unit 151 to output screen information 300′ including the second edition background 323 and indicating a current time.

A control method of changing a shape of the hands-portion 302 will be explained with reference to FIG. 4C. Once a menu icon corresponding to the hands-portion 302 is selected, the controller 180 controls the display unit 151 to output the edition screen 400 including a first hands-image 312.

Once a specific type of touch input is applied to the edition screen 400, the controller 180 controls the display unit 151 to change the first hands-image 312, into a second hands-image 322. The specific type of touch input may be a touch input consecutively applied along the inactive region 410.

Once the storage control command is applied to the display unit 151, the controller 180 controls the display unit 151 to output screen information 300′ including the second hands-image 322 and indicating time information.

In an embodiment, content to be changed may be selected by a user. Further, a plurality of graphic images corresponding to content and stored in the memory 170 may be provided based on one touch input differentiated from another touch input. Further, since a screen to which the changed graphic image has been applied is displayed on the edition screen, a user can pre-check a graphic image to be applied to screen information.

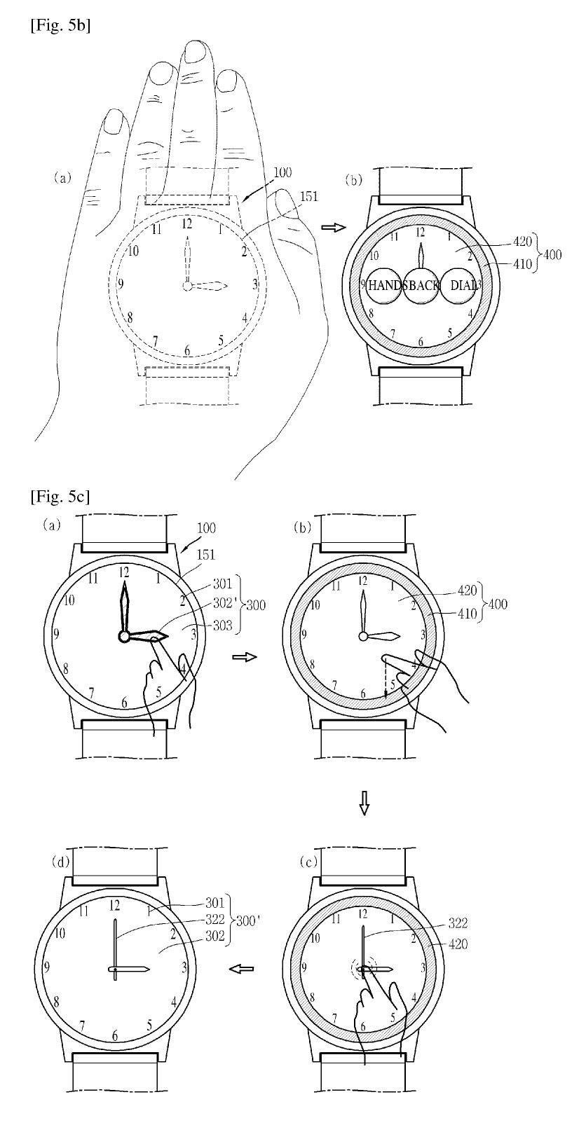

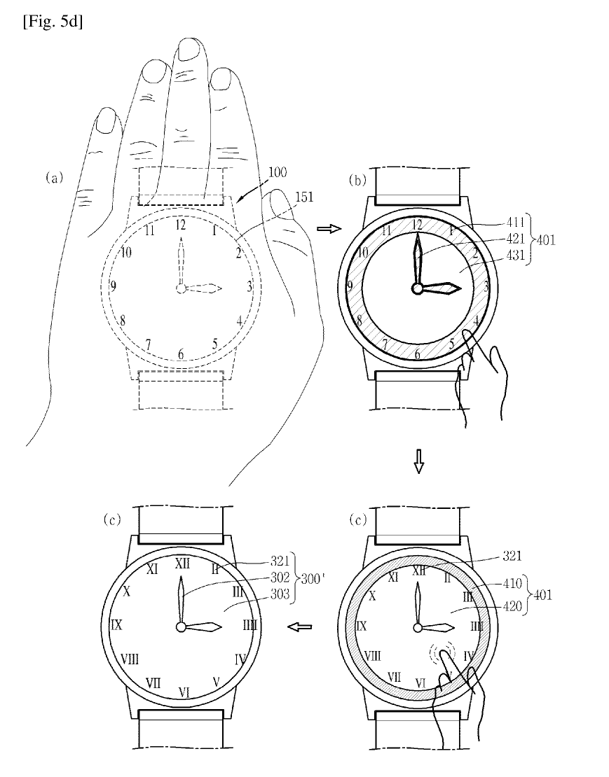

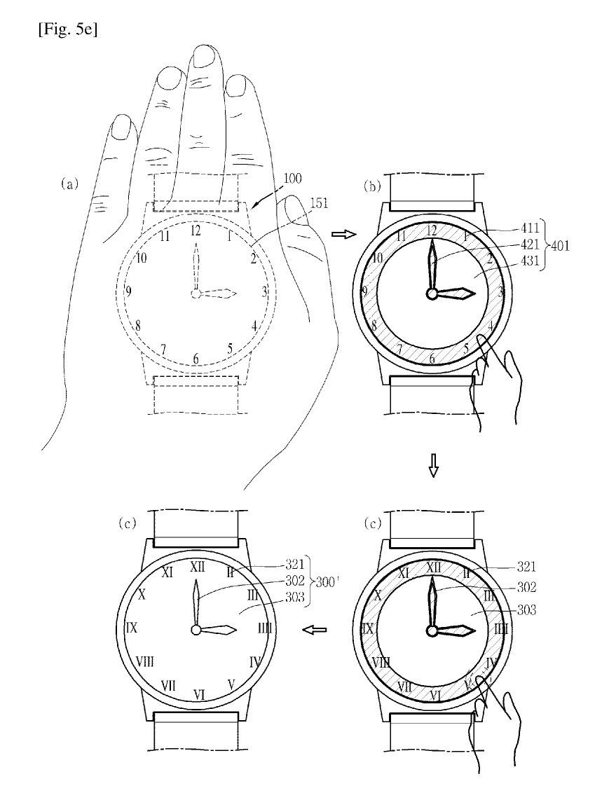

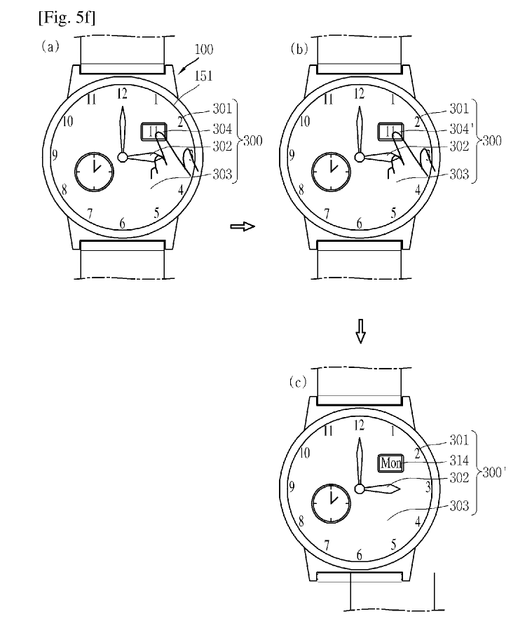

FIGS. 5A to 5F are conceptual views illustrating a control method of activating an edition mode while time information is being output. A user may apply an edition control command to the display unit 151 according to various embodiments while time information is being output, thereby executing an edition mode for partially or wholly editing a plurality of contents included in the time information.

Referring to FIG. 5A, the controller 180 activates the edition mode based on a consecutive touch input applied along the hands-portion 302. In the edition mode, the controller 180 controls the display unit 151 to output the edition screen 400 including the edition menu 420, and the inactive region 410 formed to enclose the edition menu 420.

The hands-portion 302 may be composed of an hour hand indicating an hour(s) and a minute hand indicating a minute(s) on the display unit 151. The hour hand and the minute hand are connected to each other by a point, thereby having a specific angle therebetween. The touch input for activating the edition mode may be a drag touch input starting from one end of the hour hand to one end of the minute hand, in a consecutive manner.

The touch input may be a consecutive touch input applied to form a path having an angle corresponding to an angle between the hour hand and the minute hand, and applied to one region on the display unit 151.

In this embodiment, a type of the touch input for executing the edition mode is defined, based on a shape of the hands-portion corresponding to a current time. Such touch input may be differentiated from various touch inputs applied to the display unit 151 for execution of specific functions.

Referring to FIG. 5B, the controller 180 activates the edition mode when a region on the display unit 151 more than a preset range is blocked by a hand.

For instance, when touch inputs more than a preset range are simultaneously applied to the display unit 151, the display unit 151 may activate the edition mode. Alternatively, when it is sensed, by at least one proximity sensor formed near the display unit 151, that a user's hand is positioned near the display unit 151, the display unit 151 may activate the edition mode.

A control method of activating an edition mode to edit one content selected from a plurality of contents, will be explained with reference to FIG. 5C. Referring to FIG. 5C(a), the display unit 151 outputs the time information 300 including the dial portion 301, the hands-portion 302, and the background image 303.

The controller 180 controls the display unit 151 to transform the hands-portion 302 into an edition image 302′, based on a preset type of touch input applied to the hands-portion 302 of the time information 300.

If a preset time lapses in a state where the edition image 302′ has been output, the display unit 151 outputs the edition screen 400.

If a user's additional touch input is applied to the display unit 151 in a state where the edition image 302′ has been output, the edition screen 400 for editing the hands-portion 302 is output. The additional touch input may be performed based on a control command for activation of the edition mode according to various embodiments.

The controller 180 outputs the second hands-image 322 based on a touch input applied to the edition screen 400, and controls the display unit 151 to output screen information 300′ including the second hands-image 322, based on a storage control command.

If the edition mode is activated in a selected state of at least one content based on a user's setting, providing graphic images with respect to other contents may be restricted.

Referring to FIG. 5D, when a user's hand is positioned on the display unit 151, the controller 180 may activate the edition mode by sensing a touch of the user's hand or based on sensing using a proximity sensor.

The controller 180 controls the display unit 151 to output an edition selection screen 401 when the edition mode is activated. The edition selection screen 401 may include a first region 411 corresponding to the dial portion, a second region 421 corresponding to the hands-portion, and a third region 431 corresponding to the background image. Each of the first to third regions 411, 421 and 431 is output in a transformed state, such that the plurality of contents are differentiated from each other. For instance, the controller 180 controls the display unit 151 to form division lines at each content.

The controller 180 may select content to be edited, based on touch inputs applied to the first to third regions 411, 421 and 431. Referring to FIGS. 5D(b) and (c), the controller 180 controls the display unit 151 to output the edition screen 400, for edition of the dial portion based on a touch input applied to the first region 411.

The edition screen 400 includes the second dial image 431. The controller 180 controls the display unit 151 to select other graphic image based on a touch input applied to the edition screen 400, or controls the display unit 151 to output the screen information 300′ to which the second dial image 321 has been applied, based on a storage control command.

An edition method according to another embodiment will be explained with reference to FIG. 5E. The controller 180 activates the edition mode based on a palm touch input applied onto the display unit 151, or based on a user's control command sensed by the proximity sensor.

The controller 180 controls the display unit 151 to output the edition selection screen 401 in the edition mode. The edition selection screen 401 includes the first to third regions 411, 421 and 431.

The controller 180 controls the display unit 151 to output graphic images of content corresponding to the first region 411, based on a touch input applied to the first region 411. The controller 180 controls the display unit 151 to output the second dial image 321 to the dial portion, based on a touch input applied to the first region 411.

The controller 180 may change the second dial image 321 into other graphic image, based on a touch input applied to the display unit 151. The controller 180 controls the display unit 151 to output the screen information 300′ including the second dial image 321, based on a storage control command applied to the edition selection screen 401.

In this embodiment, the controller 180 restricts output of the edition screen 400 by the display unit 151 in the edition mode. In this embodiment, a user may check a graphic image applied to the screen information on the display unit, the screen information not converted to an edition screen. Then, the user may store the graphic image.

A control method of changing an additional information window 304 included in the time information 300 will be explained with reference to FIG. 5F. The additional information window 304 serves to provide additional information as well as a current time, based on a user's setting. A type of information included in the additional information window 304, a size and a shape of the additional information window 304 have no restrictions. For instance, the additional information window 304 may include a current date, day, weather, a current time in other country (nation), etc.

The controller 180 may change a current state of the additional information window 304 into an edition state, based on a touch input applied to the additional information window 304. For instance, the display unit 151 may change a shape of the additional information window 304, or may highlight the additional information window 304. The controller 180 controls the display unit 151 to output a window image 314, based on a touch input applied to the additional information window 304. For instance, the window image 304 may be implemented as information displayed on the additional information window 304 is changed, or as a shape of the additional information window 304 is changed.

Further, the controller 180 may control the display unit 151 to provide other window image, based on an additional touch input applied to the window image 314. Further, the controller 180 may control the display unit 151 to output the screen information 300′ including the window image 314, based on a storage control command.

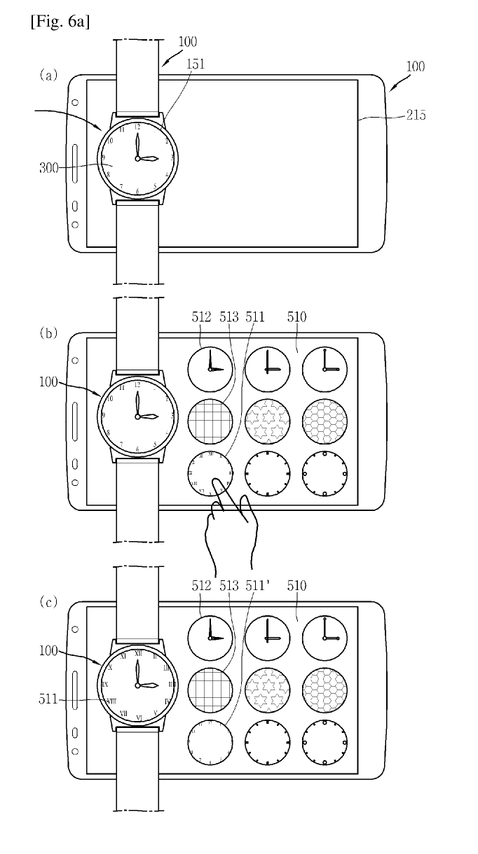

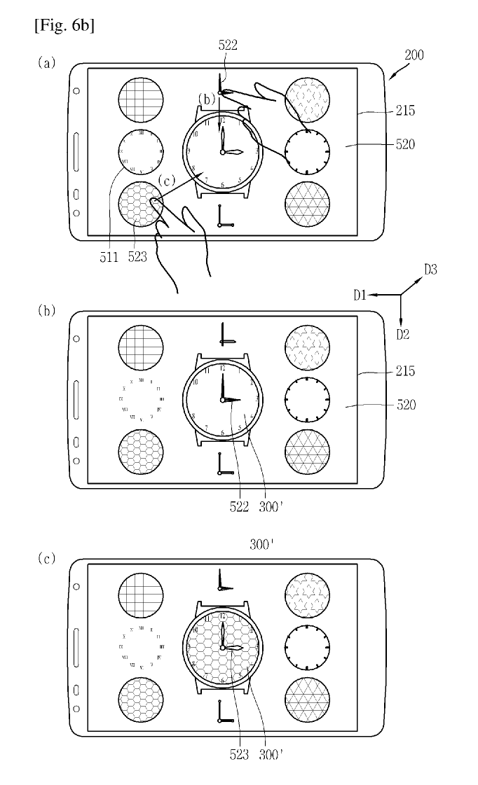

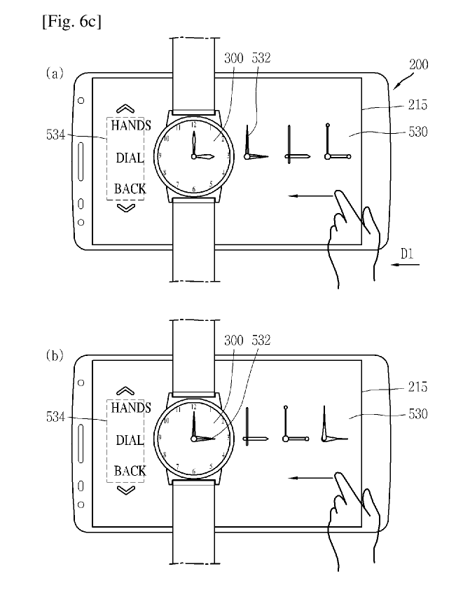

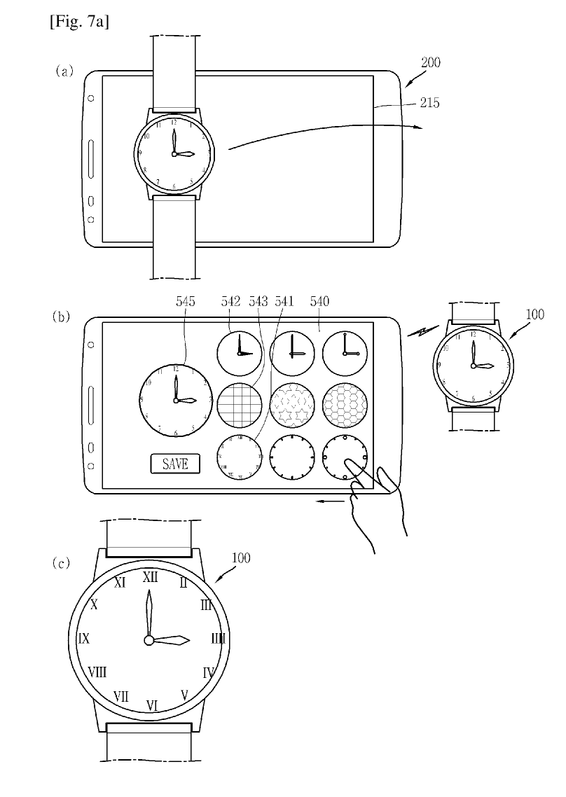

The FIGS. 6A to 6C are conceptual views illustrating a control method of changing time information using a mobile terminal according to an embodiment.

Referring to FIG. 6A, the watch type terminal may be wirelessly connected to the mobile terminal 200. For instance, when the body of the watch type terminal 100 is disposed on the display unit 251 of the mobile terminal 200 in an overlapped manner, the controller 180 controls the wireless communication unit 110 to be wirelessly connected to the mobile terminal 200. However, a device wirelessly connected to the watch type terminal 100 is not limited to the mobile terminal 200. That is, any external device including the display unit 151 for outputting an image can be used.

When the watch type terminal 100 is wirelessly connected to the mobile terminal 200, the controller 180 may transmit information on the watch type terminal 100 to the mobile terminal 200.

The display unit 215 of the mobile terminal outputs a first edition screen 510 including graphic images corresponding to a plurality of contents which constitute screen information of the watch type terminal 100. The first edition screen 510 includes a plurality of graphic images corresponding to each content. That is, the first edition screen 510 includes a plurality of dial images 511, a plurality of hands images 512, and a plurality of edition backgrounds 513. On the first edition screen 510, the plurality of graphic images are arranged with a preset layout. The number of the graphic images included in the first edition screen 510 is not limited to that shown in the drawings.

The wireless communication unit receives information on a graphic image selected by a touch input applied to the display unit 215, and outputs screen information 300′ including the selected graphic image to the display unit 151 based on a wireless signal.

For instance, the wireless communication unit 110 receives information formed based on a touch input applied to the dial image 511, and the controller 180 controls the display unit 151 to output the screen information 300′ including the dial image 511 based on the information.

The display unit 215 changes the dial image 511 into other graphic image 511′ based on a touch input applied to thereto. For instance, the graphic image 511′ may correspond to content included in initial time information 300.

Although not shown, additional graphic images may be provided based on a touch input applied to the display unit 215.

A control method of providing a second edition screen including graphic images according to another embodiment will be explained with reference to FIG. 6B.

Referring to FIG. 6B(a), the body of the watch type terminal 100 including the display unit 151 may be separated from the case 101. Once the body is arranged on the display unit 215 of the mobile terminal 200, the wireless communication unit 110 may transmit information on the watch type terminal to the mobile terminal 200.

Based on the information on the watch type terminal 100, the display unit 215 outputs a second edition screen 520 including a plurality of graphic images corresponding to a plurality of contents. The plurality of graphic images corresponding to different types of contents are arranged in directions crossing each other.

That is, the plurality of dial images 511 are arranged in a first direction (D1) in a state where the display unit 151 is interposed therebetween. A plurality of hands images 522 are arranged in a second direction (D2) crossing the first direction (D1), in a state where the display unit 151 is interposed therebetween. A plurality of edition backgrounds 523 are arranged in a third direction (D3) crossing the first direction (D1) and the second direction (D2), in a state where the display unit 151 is interposed therebetween.

The controller 180 controls the display unit 151 to output screen information including a selected graphic image, based on a touch input applied to the graphic image. The touch input may be a consecutive touch input applied in the first to third directions (D1, D2 and D3).

Referring to FIGS. 6B(a) and (b), the controller 180 controls the wireless communication unit 110 to receive information on the hands-image 522, such that the screen information 300′ includes the hands-image 522, based on a consecutive touch input applied in the second direction (D2). Therefore, the display unit 151 can immediately display the screen information 300′ including the hands-image 522, based on the information. The hands-image 522 on the screen information 300′ may be converted into a graphic image corresponding to the hands-image.

Referring to FIGS. 6B(a) and (c), the controller 180 may control the display unit 151 to output the screen information 300′ in a state where the edition backgrounds 523 are included in the screen information 300′, based on a consecutive touch input applied in the third direction (D3).

That is, in this embodiment, the plurality of graphic images are arranged on the display unit 151, and graphic images corresponding to the same content are arranged in the same direction on the display unit 151. Thus, a user can change a shape of content included in the screen information, by a touch input applied in a differentiated direction.

Further, a user can restore a shape of content into that of content included in initial time information, based on a consecutive touch input applied in an opposite direction to the touch input direction.

FIG. 6C is a conceptual view illustrating a method of controlling time information according to still another embodiment. Once the watch type terminal 100 is disposed on the display unit 215 of the mobile terminal 200, the controller 180 transmits information on the watch type terminal 100 to the mobile terminal 200, and the display unit 215 outputs a second edition screen 530 including a content list 534 and a plurality of graphic images corresponding to a selected content.

Referring to FIG. 6C, the display unit 215 outputs a plurality of hands images 532 corresponding to HANDS selected from the content list 534. Although not shown, when other content is selected based on a touch input applied to the content list 534, graphic images corresponding to said other content may be displayed.

The hands-image 532 may be selected based on a touch input applied to the display unit 215, and the selected hands-image 532 may be displayed on the display unit 151. The touch input may be a consecutive touch input applied along an arrangement direction of the graphic images, or a touch input applied to the graphic image.

In this embodiment, only graphic images corresponding to content to be changed are output. This can provide an edition screen where the graphic image is selected more easily.

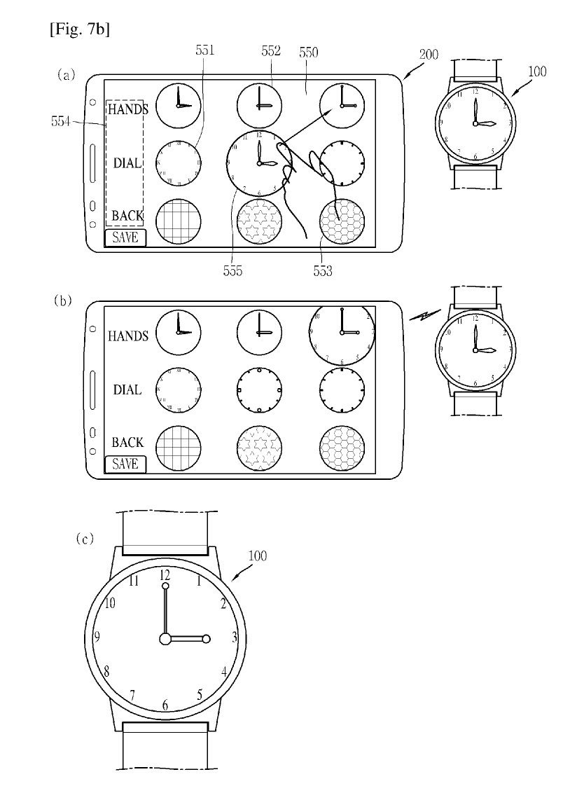

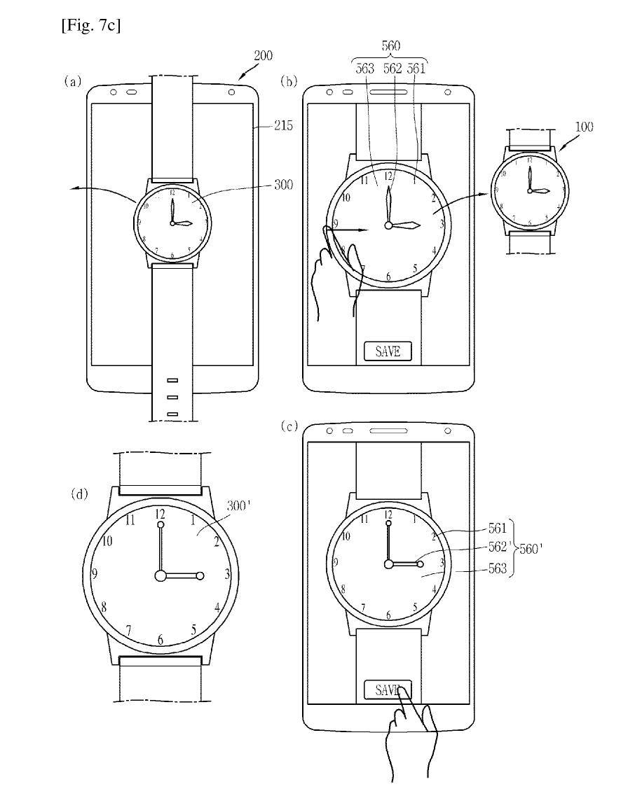

FIGS. 7A to 7B are conceptual views illustrating a control method of changing time information using a mobile terminal according to another embodiment.

Referring to FIG. 7A, when the watch type terminal 100 is positioned on the display unit 215 of the mobile terminal 200 in an overlapped manner, the controller 180 controls the wireless communication unit 110 to transmit information on the watch type terminal 100 to the mobile terminal 200.

The display unit 215 of the mobile terminal 200 outputs a fourth edition screen 540 including a corresponding image 545 of the watch type terminal, after the watch type terminal 100 is separated from the mobile terminal 200.

The corresponding image 545 is formed as an image corresponding to the display unit 151 of the watch type terminal 100, based on the information on the watch type terminal 100. That is, the corresponding image 545 includes the same information as the time information 300 output to the display unit 151.

The fourth edition screen 540 includes a plurality of graphic images corresponding to each content. That is, the fourth edition screen 540 includes a plurality of dial images 541, a plurality of hands images 542, and a plurality of edition backgrounds 543. The plurality of graphic images may be arranged with a preset layout.

The display unit 215 outputs a graphic image selected based on a touch input applied thereto, after applying it to the corresponding image 545. In this case, a user can immediately predict screen information to be output to the watch type terminal 100.

The controller 180 receives information on a selected graphic image based on a touch input applied to a storage icon included in the display unit 215, and controls the display unit 151 based on the information.

A method of changing time information according to another embodiment will be explained with reference to FIG. 7B. When a proximity state between the mobile terminal 200 and the watch type terminal 100 is not maintained, i.e., when the watch type terminal 100 is separated from the mobile terminal 200, the display unit 215 of the mobile terminal 200 outputs a fifth edition screen 550 including a corresponding image 555 of the watch type terminal 100.

The fifth edition screen 550 includes the corresponding image 555, dial images 551, hands images 552, and edition backgrounds 553, and may further include a content list 554 for selectively outputting a plurality of graphic images corresponding to each content.

Content to be output to the watch type terminal 100 may be selected, based on a touch input firstly applied to the corresponding image 555 on the display unit 215.

Referring to FIG. 7B(a) and (b), the display unit 215 changes a position of the corresponding image 555, based on a path of a consecutive touch input firstly applied to the corresponding image 555. When the corresponding image 555 is overlapped with a specific graphic image, the graphic image is applied to the corresponding image 555. That is, a first hands-portion included in the corresponding image 555 is changed into a dial image overlapped with the corresponding image 555.

After a touch input for selecting the graphic image is received, in a state where a selected graphic image is displayed on the corresponding image 555, the touch input may be re-applied to the corresponding image 555 such that the corresponding image 555 is displayed in an overlapped manner with other graphic image.

That is, a user may select a type of content, after pre-checking screen information to be output by overlapping the corresponding image with a graphic image.

Thus, the user can be provided with a larger amount of graphic images through the display unit 215 of the mobile terminal 200, and can form screen information by selecting a graphic image even in a separated state of the watch type terminal from the mobile terminal. Further, the user can pre-check screen information to be output to the display unit 151, the screen information combined with content. This can allow the user to configure and set screen information through more various combinations.

FIG. 7C is a conceptual view illustrating a control method of changing time information using the mobile terminal 200 according to another embodiment.

When a contact state (or a proximity state) between the watch type terminal and the mobile terminal 200 is released, the mobile terminal outputs a sixth edition screen 560 on the display unit 215, based on information received from the watch type terminal. The sixth edition screen 560 includes a corresponding image corresponding to the watch type terminal 100. For instance, the sixth edition screen 560 may correspond to an enlarged shape of the display unit 151. That is, the sixth edition screen 550 may include a corresponding dial portion 561, a corresponding hands-portion 562 and a corresponding background image 563.

The display unit 215 outputs the same time information as the time information 300, and changes a shape of content included in the time information based on a touch input applied thereto.

For instance, the display unit 215 may change the corresponding hands-portion 562 into other graphic image 562′, based on a consecutive touch input applied thereto. The display unit 215 outputs screen information 560′ including the selected graphic image.

The controller 180 controls the wireless communication unit 110 to receive information on the screen information 560′, based on a storage control command applied to the display unit 215. Thus, the controller 180 controls the display unit 151 to output the same screen information 300′ as the screen information 560′.

Therefore, a user can change time information on a large screen, using an image corresponding to time information of the watch type terminal 100, the image output to the mobile terminal 200.

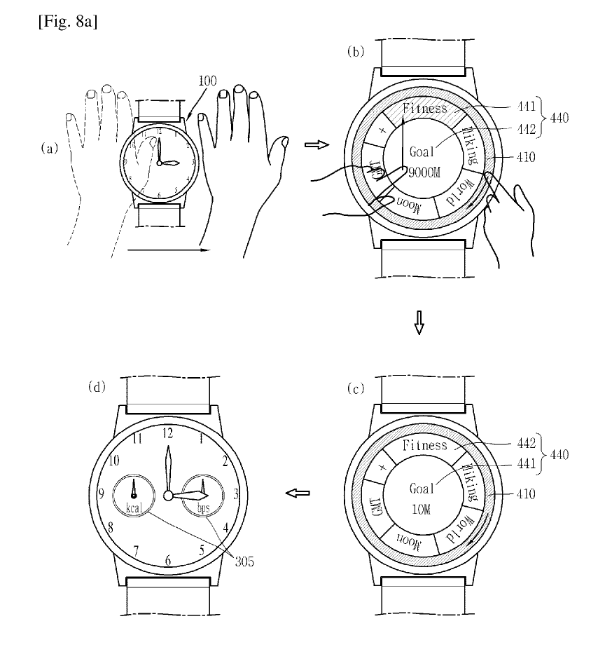

FIGS. 8A and 8B are conceptual views illustrating a control method of changing time information according to a mode selection.

Referring to FIG. 8A, the controller 180 activates an edition mode based on a touch input applied to the display unit 151. The controller 180 controls the display unit 151 to output a mode selection menu 440 together with the inactive region 410, in the edition mode. The mode selection menu 440 includes a plurality of mode menus 441, and a detailed setting window 442 for a selected mode.

The plurality of mode menus 441 may be arranged along the inactive region 410, and may be selected based on a touch input applied along the inactive region 410. A user may generate a specific mode by combining desired information with each other.

An option to be set by a user may be input as a control command is applied to the detailed setting window 442. For instance, when a fitness mode is set, the controller 180 executes a function to display the number of steps (paces) in the fitness mode, and controls the display unit 151 to input a user's goal number of steps to the detailed setting window 442. The controller 180 may control the goal number of steps, based on a touch input applied to the detailed setting window 442.

Referring to FIG. 8A(c), the controller 180 controls the display unit 151 to output a plurality of information windows 305 including items set on the detailed setting window 442, and data corresponding to a plurality of mode menus. An output position and a shape of the plurality of information windows 305 are pre-stored in correspondence to a selected mode. For instance, in case of a fitness mode, the plurality of information windows may include a first information window configured to output the number of a user's steps and to display the goal (target) number of steps, and a second information window indicating a currently-measured atmospheric pressure. However, the information windows in the mode may be controlled so as to be editable based on a user's setting.

FIG. 8B is a conceptual view illustrating information windows 305 output in various modes. FIG. 8B(a) is a conceptual view illustrating an information window 305a corresponding to a hiking mode. In the hiking mode, the information window 305a may include a first information window configured to sense and output the number of a user's steps (paces), a second information window configured to provide direction information according to a compass function, and a third information window configured to output altitude information using an atmospheric pressure sensor.

FIG. 8B(b) is a conceptual view illustrating an information window 305b corresponding to a world time mode. In the world time mode, the information window 305b outputs at least one set world time. For instance, as shown, three information windows for indicating times in three cities may be implemented.

FIG. 8B(c) is a conceptual view illustrating screen information 300″ corresponding to a Greenwich Mean Time (GMT) mode. The controller 180 controls the display unit 151 to change a position of a hands-portion indicating a dial portion, by converting a current time into Greenwich Mean Time (GMT).

FIG. 8B(d) is a conceptual view illustrating an information window 305c corresponding to a moon phase mode. In the moon phase mode, the controller 180 controls the display unit 151 to receive data on shapes of the moon observed at a current time, and to output a shape of the moon to the information window 305c having a preset shape.

That is, a user can select a desired mode, and add required information to the screen information.

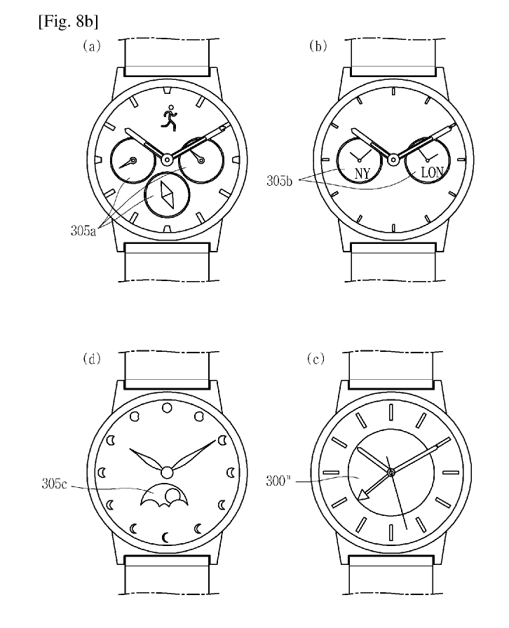

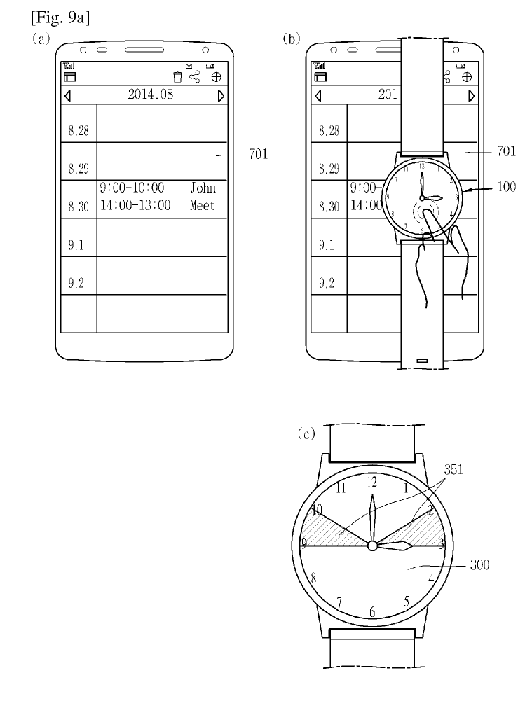

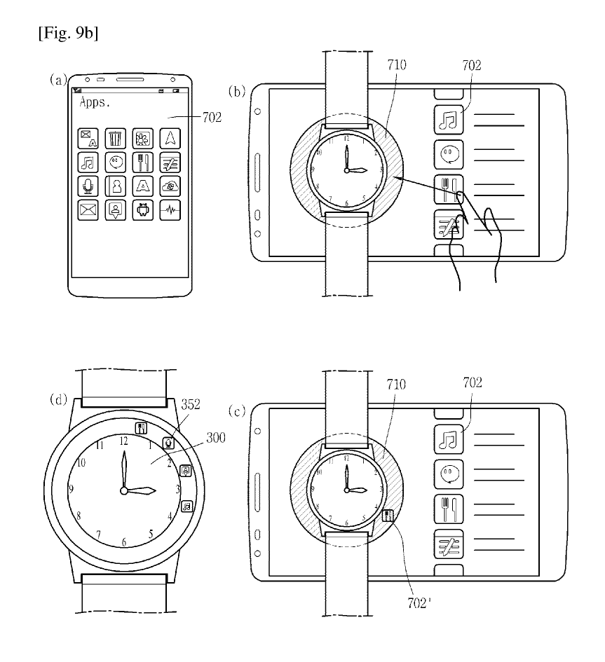

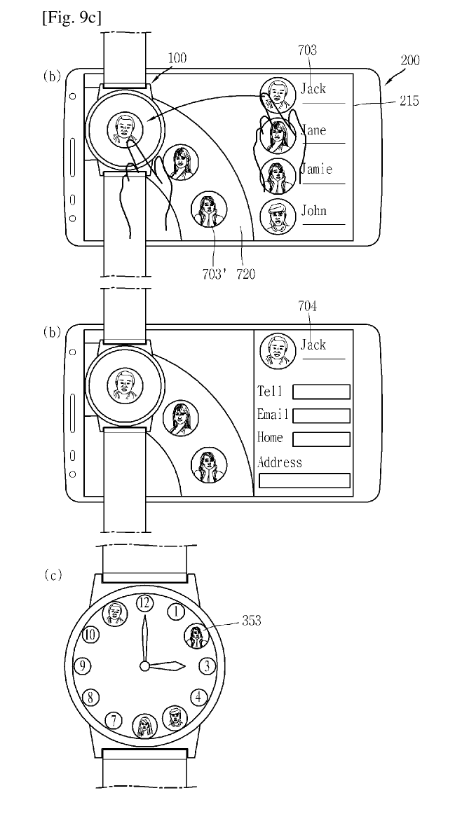

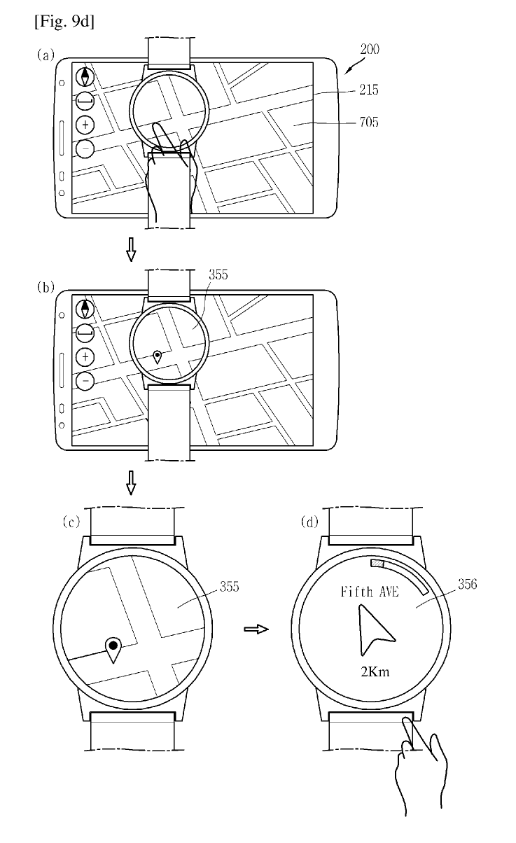

FIGS. 9A to 9D are conceptual views illustrating a control method of adding storage information stored in the mobile terminal 200, to time information.

Referring to FIG. 9A(a), the display unit 215 of the mobile terminal 200 outputs information 701 stored in a corresponding date and corresponding times. The wireless communication unit 110 receives the information 701 when the watch type terminal 100 is arranged close to the display unit 215 of the mobile terminal 200. For instance, the controller 180 controls the display unit 151 to selectively receive only information input in correspondence to a current date, and to output a record image 351 indicating the information 701.

For instance, the record image 351 may be composed of an image and a text displayed together with the dial portion, and may be displayed on the background image.

Therefore, a user can more easily recognize information corresponding to a current date and a current time, by displaying information stored in the mobile terminal 200 on the watch type terminal.

Referring to FIG. 9B(a), the display unit 215 of the mobile terminal 200 displays a plurality of icons 702 corresponding to a plurality of applications installed in the mobile terminal 200. When the watch type terminal 100 is overlapped with the display unit 215 where the plurality of icons 702 have been output, the display unit 215 displays a first edition region 710 at a position close to the watch type terminal 100.

Referring to FIGS. 9B(b) and (c), the controller 180 receives data on a selected icon 702, based on a touch input applied to the icon 702 and the first edition screen 710. The display unit 215 outputs the selected icon 702 to the first edition screen 710.

The display unit 151 of the watch type terminal 100 outputs an icon 352 of a received application, using data on the received application. The controller 180 controls the display unit 151 to output the time information 300 composed of the hands-portion, the dial portion and the background image, together with the icon 352.

Although not shown, the controller 180 may execute an application corresponding to an icon on the display unit 151, based on a touch input applied to the icon.

A control method of outputting address information stored in the memory of the mobile terminal 200, together with the time information 300, to the watch type terminal 100, will be explained with reference to FIG. 9C.

When the watch type terminal 100 is positioned close to the display unit 215, the display unit 215 outputs address information 703, and displays a second edition region 720 at a position adjacent to the watch type terminal 100. The address information 703 may be composed of a plurality of images and texts corresponding to stored addresses.

The controller 180 controls the wireless communication unit 110 to selectively receive the address information 703, based on a consecutive touch input applied such that images included in the address information 703 are positioned on the second edition region 720.

Referring to FIG. 9C(b), the display unit 251 outputs edition information 704, based on a touch input applied to an image on the second edition region 720. For instance, information on an image displayed on the display unit 251 can be edited.

The controller 180 of the watch type terminal may change part of the dial portion, into images corresponding to the images included in the address information. Although not shown, the controller 180 may execute a function using the address information, based on a touch input applied to an image displayed on part of the dial portion. For instance, the function may correspond to a call function, a message function, an e-mail send function, etc.

In the present invention, a user can output part of information stored in the mobile terminal 200, together with time information. Thus, not only a current time, but also information to be remembered can be displayed.

A control method of outputting map information on the display unit 151 will be explained with reference to FIG. 9D. Referring to FIG. 9D(a), when the watch type terminal 100 is overlapped with the display unit 215 of the mobile terminal 200 in a state where a map image 705 has been output to the display unit 215, the controller 180 controls the display unit 151 to receive data on the map image 705, and to output a partial region 355 of the map image 705 displayed on the display unit 215, the partial region 355 blocked due to the overlapping of the watch type terminal 100. Under such configuration, the map image 705 can be consecutively output in an overlapped state of the watch type terminal on the display unit.

The controller 180 may set a target point on the map image 705, based on a touch input applied to the display unit 151 on which part of the map image 705 has been displayed. Further, the controller 180 continues to output part of the map image 705, based on data on the received map image 705, even when the watch type terminal 100 is separated from the mobile terminal 200.

The controller 180 may execute an application related to the map image 705, based on the set target point. Therefore, a user can perform an application which was being executed in the mobile terminal 200, at the watch type terminal. The display unit 151 of the watch type terminal outputs an execution screen 356 of the application.

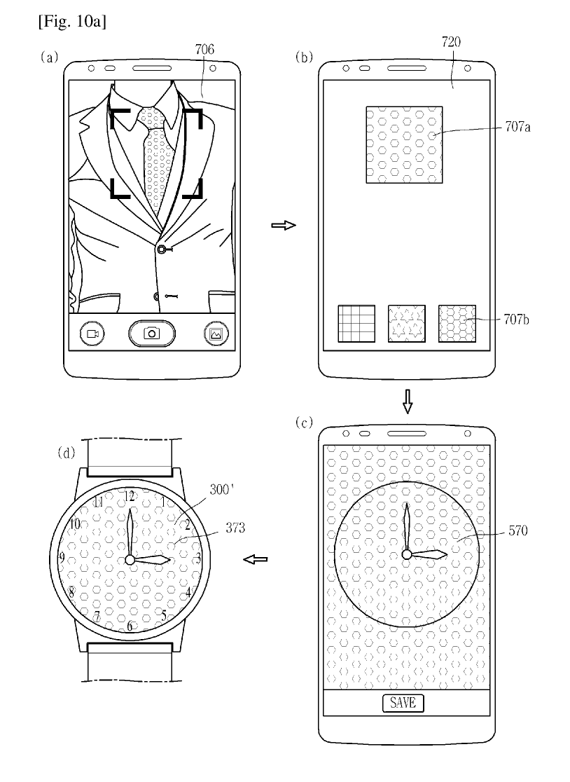

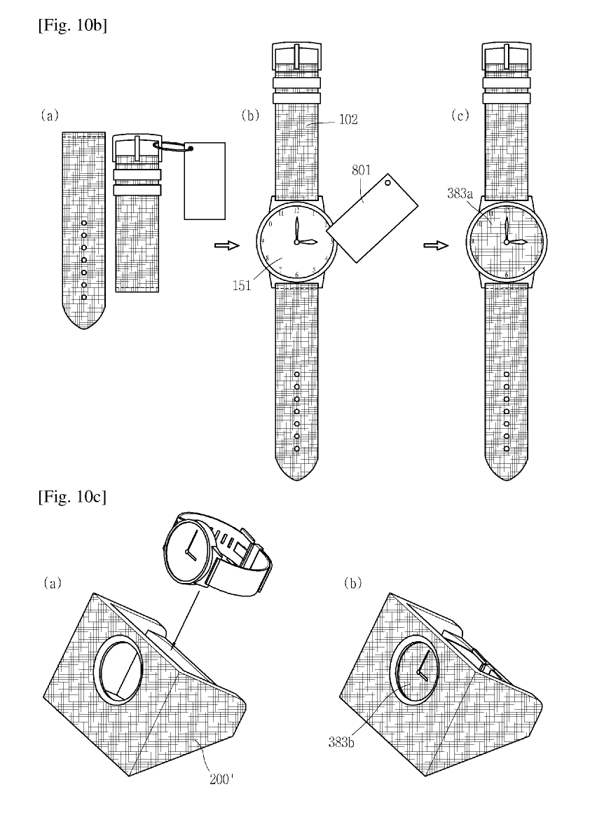

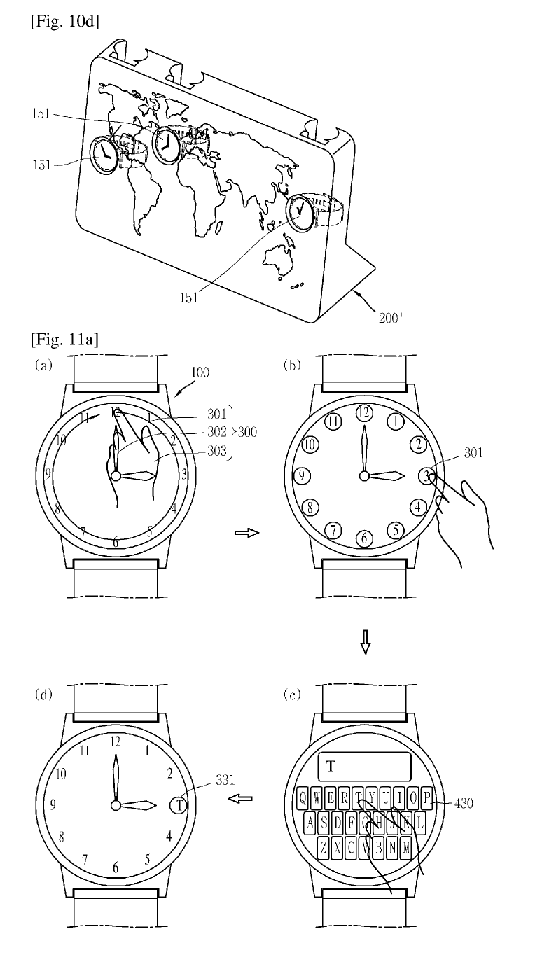

FIGS. 10A to 10D are conceptual views illustrating a control method of changing time information using external information.

Referring to FIG. 10A, the mobile terminal may acquire external environments using a camera. For instance, a user may capture his or her clothes, using a camera of the mobile terminal 200. The mobile terminal 200 extracts a color 707a of a region selected by a user among the image acquired by the camera. The mobile terminal 200 may pattern the color 707a using pre-stored pattern information 707b.

The display unit 215 of the mobile terminal 200 outputs a pattern image 570 from the color 707a. In a case where the watch type terminal 100 is wirelessly connected to the mobile terminal 200, the display unit 215 further outputs a shape of the watch type terminal on the pattern image 570.

The controller 180 controls the display unit 151 to output screen information 300′ including the pattern image 570 as a background image 373, based on a storage control command applied to the mobile terminal 200.

Therefore, a user can edit time information indicating a current time, while he or she is being provided with a background image visually well-matched with external environments.

FIG. 10B is a conceptual view illustrating a control method of editing time information, using information on a band portion. In this embodiment, information on the band portion is stored in a tag 801 attached to the watch type terminal when the watch type terminal is fabricated and is presented on the market. The mobile terminal 200 may receive to read the information on the band portion, the information stored in the tag 801.

A screen information sample, implemented as a plurality of contents are formed in different designs, may be sold in the form of the tag. For instance, screen information data, formed through a combination of different designs or formed using a specific theme, may be sold together with the watch type terminal. Alternatively, the screen information data may be sold in the form of an application of the mobile terminal. Still alternatively, each of graphic images corresponding to each content may be sold as a single product. In this case, the single product may be configured to be transmitted to a watch type terminal on a server, such that other user receives a present in the form of data.

The controller 180 controls the display unit 151 to output screen information having an image as a background image 383a, based on the information on the band portion, the image similar to a pattern of appearance of the band portion. The image similar to the pattern may be pre-stored in the memory of the watch type terminal.

A control method of changing time information when the watch type terminal is mounted to a charging device 200′ will be explained with reference to FIG. 10C. Referring to FIG. 10C, when the watch type terminal 100 is accommodated in the charging device 200′, the display unit 151 is exposed to the outside, due to an opening of the charging device 200′.

Once the watch type terminal is mounted to the charging device, the controller 180 controls the display unit 151 to receive information on a pattern of appearance of the charging device, and to output screen information having an image as a background image 383b, the image similar to the pattern.

Under such configuration, when the watch type terminal 100 is mounted to the charging device, integrated feeling of the watch type terminal 100 with the charging device can be provided.

FIG. 10D is a conceptual view illustrating a control method of changing time information, when the watch type terminal is mounted to a charging device 200′ having a plurality of openings. One surface of the charging device 200′ is provided with a map image, and another surface thereof is provided with a plurality of openings.

When mounted to one of the plurality of openings, the watch type terminal receives information corresponding to the opening. For instance, the charging device 200′ may correspond to each opening, and may store therein data on a current time in each country (nation).

That is, when the watch type terminal is mounted to one opening, the controller 180 receives data on time information corresponding to the opening, and changes time information based on the received data. That is, a position of a dial portion, indicated by a hands-portion, may be changed based on the data.

Under such configuration, while the watch type terminal is charged at the charging device, a user can be provided with time information changed for application of a desired nation.

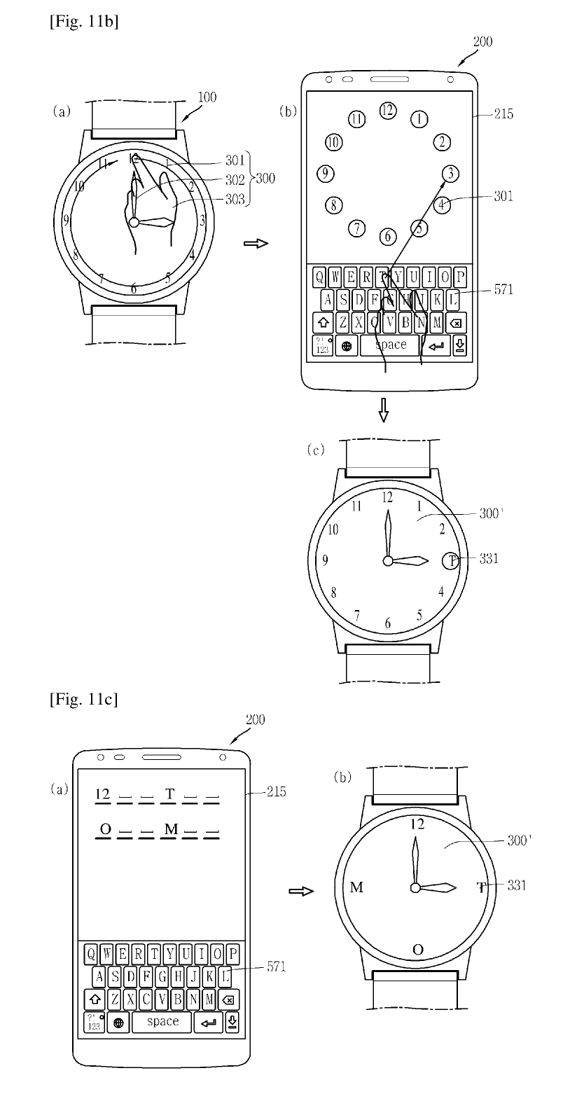

FIGS. 11A to 11C are conceptual views illustrating a control method of changing part of a dial portion.

Referring to FIG. 11A(a), the display unit 151 outputs the time information 300 including the dial portion 301, the hands-portion 302 and the background image 303. When a consecutive touch input is input along the dial portion 301 composed of a plurality of dials, the controller 180 activates an edition mode for individually editing the plurality of dials.

The controller 180 controls the display unit 151 to receive a touch input on each dial. Referring to FIGS. 11A(b) and (c), the controller 180 selects one or more dials, based on one or more touch inputs applied to the plurality of dials. Upon selection of a dial to be edited, the controller 180 controls the display unit 151 to output a virtual keyboard 430. The virtual keyboard 430 may include various characters, numbers, signs, etc., and a shape of the virtual keyboard 430 is not limited to one shown in the drawings.

The controller 180 controls the display unit 151 to change the selected dial into an image 331 based on a touch input applied to the virtual keyboard 430, and to output the image 331.

In this embodiment, since only part of the plurality of dials can be selectively changed, a user can edit the screen information so as to have more various designs.

A control method of editing dials using the mobile terminal 200 will be explained with reference to FIG. 11B. The controller 180 transmits a wireless signal to the mobile terminal 200 wirelessly connected to the watch type terminal, based on a touch input applied to the dial portion 301, such that the display unit 215 outputs a virtual keyboard 571 together with the dial portion 301.

The display unit 215 may display the plurality of dials, in the same arrangement manner as that on the display unit 151 of the watch type terminal 100. The controller 180 may change part of the plurality of dials, based on a touch input applied to the virtual keyboard 571. For instance, the controller 180 may select a dial to be changed, and may change the selected dial, based on a touch input moving from the virtual keyboard to a single dial.

The display unit 151 displays screen information 300′ including the changed image 331.

FIG. 11C is a conceptual view illustrating a control method of changing time information according to still another embodiment.

The display unit 215 displays inputs regions corresponding to the plurality of dials included in the dial portion. The input regions may be formed as 12 empty spaces. The controller 180 may add desired images to the empty spaces, and the empty spaces are set to correspond to the plurality of dials, respectively. Thus, a user can edit all of the plurality of dials, and can display location regions of the dials, as empty spaces.

Although not shown, the controller 180 may select a font or a design of each dial, and the display unit 215 may output a sample image indicating the font of the dial, etc.

In this embodiment, the dials can be edited in more various manners, using the large display unit 215 of the mobile terminal 200.

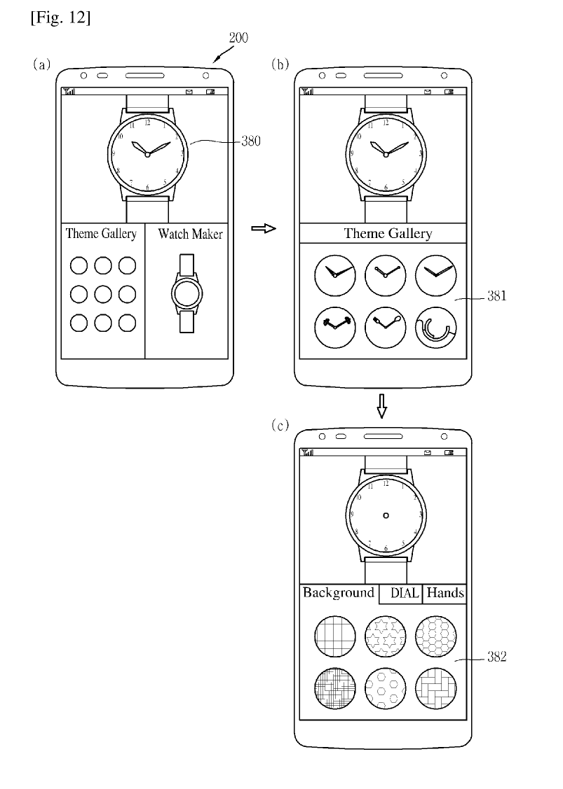

FIG. 12 is a conceptual view illustrating an edition screen of the mobile terminal 200 for setting the display unit 151 of the watch type terminal. In this embodiment, the mobile terminal 200 executes an application for editing the display unit 151 of the watch type terminal.

The display unit 215 of the mobile terminal 200 outputs a first screen 380 for displaying a watch type terminal interworked with the mobile terminal 200. When the mobile terminal 200 is interworked with a plurality of watch type terminals, a user may select a watch type terminal to be edited, based on a touch input.

Referring to FIG. 12(b), the display unit 215 may display a second screen 381 for outputting a preset theme screen composed of a hands-portion, a dial portion and a background image through a combination. A user may change a plurality of contents at a time, by selecting the preset theme screen.

Referring to FIG. 12(c), the controller 180 controls the display unit 215 to output screen information by including a third screen 382 having a plurality of taps corresponding to the plurality of contents, such that the plurality of contents are independently changed. The third screen 382 outputs graphic images corresponding to each of the plurality of contents, each content selected by the tap.

That is, a user can change a plurality of contents included in time information, using an application of the mobile terminal 200.

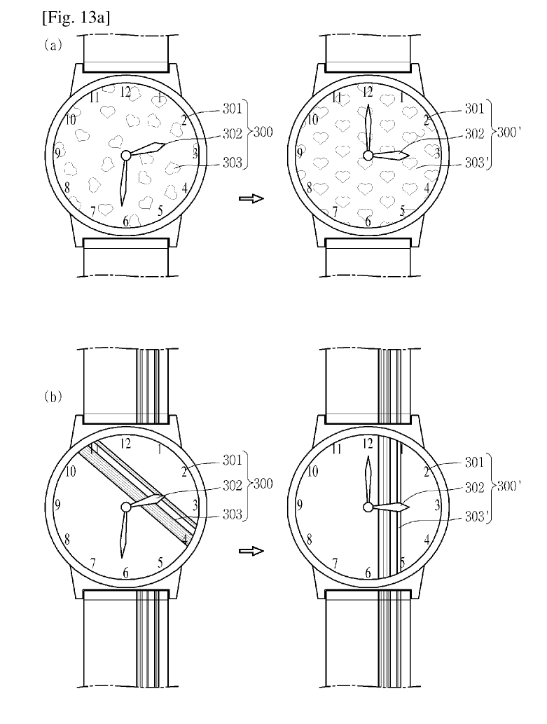

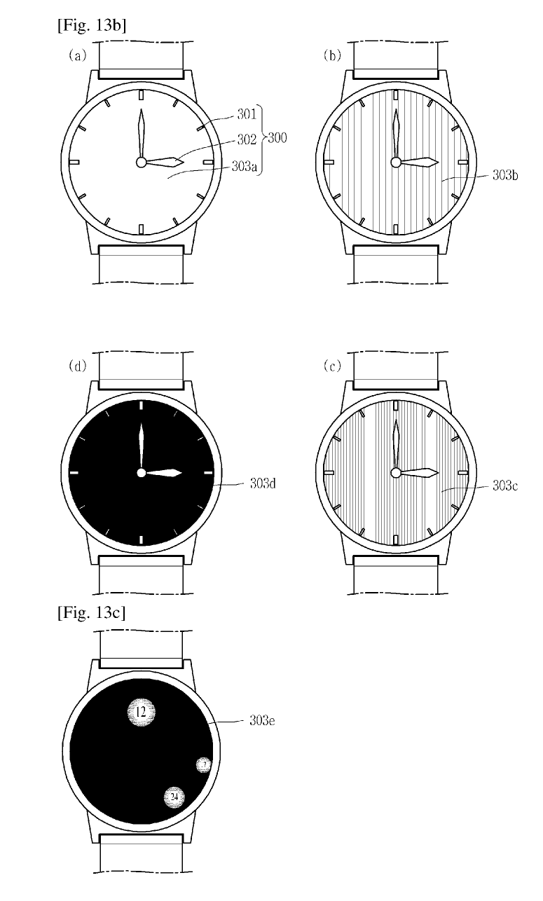

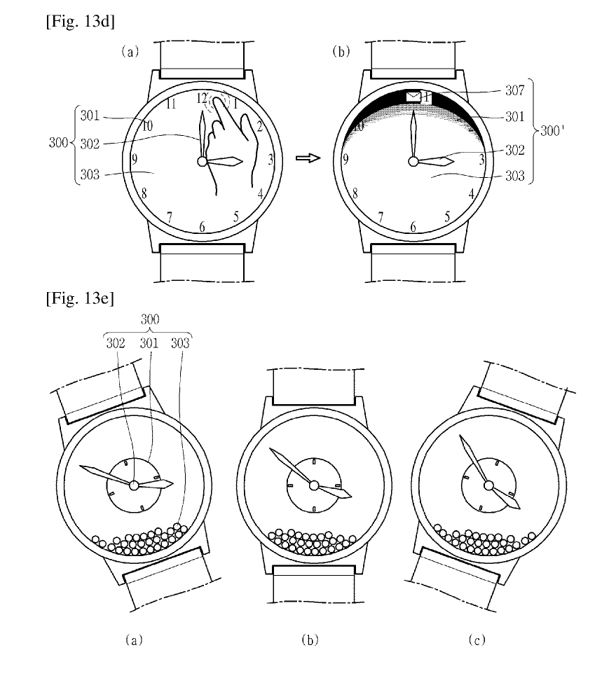

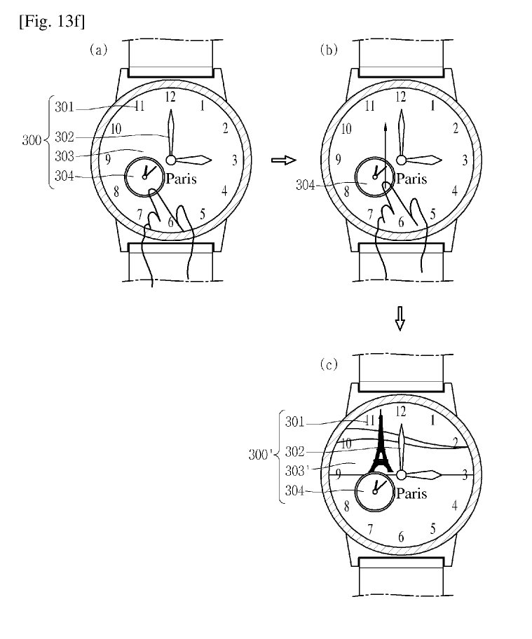

FIGS. 13A to 13F are conceptual views illustrating a control method of changing time information using received external information.

A control method of changing a background image according to a lapse of time will be explained with reference to FIG. 13A. Referring to FIG. 13A(a), the background image 303 includes a plurality of graphic images (heart images) arranged in an irregular manner. When a current time corresponds to every hour exactly, the controller 180 controls the display unit 151 to output screen information 300′ including a transformed image 303′ having a plurality of graphic images arranged in one direction.

Referring to FIG. 13A(b), the background image 303 includes line images extending to one direction. Line images, extending from the display unit 151 to one direction, are also formed at the band 102.

When a current time corresponds to every hour exactly, the controller 180 controls the display unit 151 to output a transformed image 303′ where the line images on the display unit 151 are aligned with the line images on the band 102.

In this embodiment, as the background image is transformed to a specific image at a specific hour, a user can be provided with new aesthetic feeling according to a lapse of time.

Referring to FIG. 13B, the controller 180 changes a background image of the display unit 151 according to change of external environments. FIG. 13B(a) shows time information in a default state. FIG. 13B(b) shows a background image 303b when the display unit 151 is exposed to direct sunlight. FIG. 13B(c) shows a case where no touch input has been applied to the display unit 151 for a preset time. In this case, the display unit 151 outputs screen information having a lowered visibility, and outputs a background image 303c having a relatively dark color.

Referring to FIG. 13B(d), when a user is positioned at a dark place such as a movie theater, the display unit 151 includes a background image 303d having a relatively dark color, and outputs screen information including a hands-portion and a dial portion each having a relatively bright color.

The controller 180 may sense a location region of the watch type terminal and external environments using a plurality of sensors, and may change screen information based on the sensing result.

FIG. 13C illustrates a background image 303e according to another embodiment. The background image 303e includes at least one exposed region, and is formed to indicate the dial portion. The background image 303e outputs at least one dial through the exposed region. The exposed dial may correspond to an hour, a time, a second, etc.

The controller 180 controls the display unit 151 such that the exposed region of the background image 303e moves as time lapses.

A control method of changing time information when an event occurs will be explained with reference to FIG. 13D. The controller 180 outputs notification data when an event is received. For instance, the notification data may correspond to at least one of vibration, visual information and auditory information.

When an event is received, the controller 180 controls the display unit 151 to output an indicator 307 corresponding to the event, based on a touch input applied to the display unit 151.

The controller 180 controls the display unit 151 to change a shape of the background image 303, and to output the rest region in a dark color, for aesthetic feeling which seems that the indicator 307 appears while the background image 303 is pushed toward a rear direction of the display unit 151.

Although not shown, the controller 180 controls the display unit 151 to provide an image transformation that the background image 303 is rotated, based on a touch input applied to the indicator 307, and controls the display unit 151 to output information related to the event instead of the time information.

The mobile terminal 200 of FIG. 13E further includes a sensor configured to sense a gradient of the watch type terminal. In this embodiment, the background image 303 includes an image where circular beads are stacked with each other in one direction by gravity.

The controller 180 senses a gradient change of the watch type terminal by the sensor, and controls the display unit 151 to change a position of the circular beads based on the gradient change.

A control method of changing the background image 303 based on information included in an information window, will be explained with reference to FIG. 13F. Referring to FIG. 13F(a), the time information 300 includes the dial portion 301, the hands-portion 302, the background image 303 and an information window 304. The information window 304 includes time information on other city.

When a touch input firstly applied to the information window 304 is released from the background image 303, the controller 180 controls the display unit 151 to output an information image 303′ corresponding to the information window 304, to the background image 303.

For instance, the information image may means a city indicated by the information window 304. Thus, a user can easily recognize not only a current time, but also a country (nation) corresponding to time output to the information window 304.

In this embodiment, the watch type terminal can change the screen information as time lapses or using pre-stored information, without a control command applied thereto by a user.

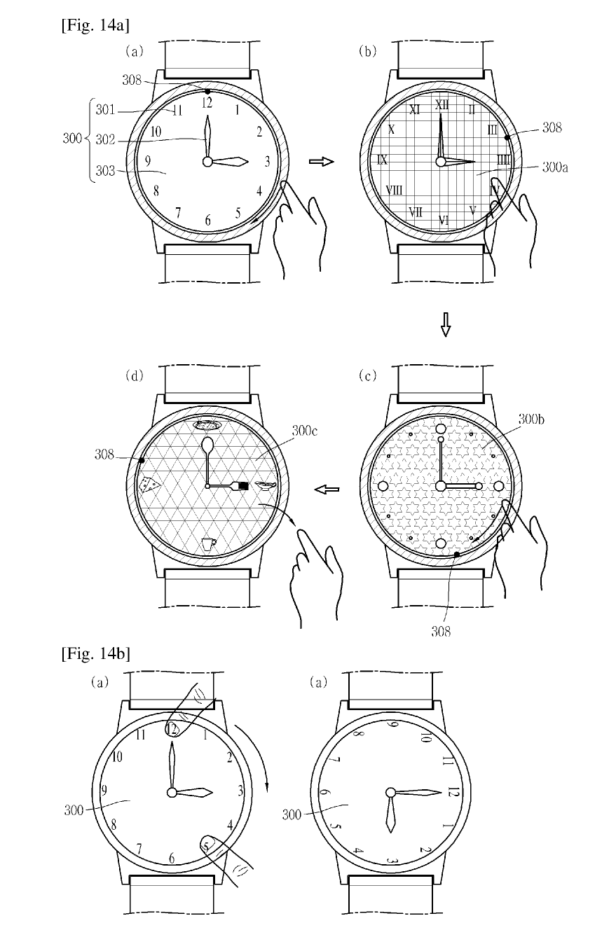

FIGS. 14A and 14B are conceptual views illustrating a control method of changing time information, based on a touch input applied to a bezel portion. The bezel portion indicates a region of the case which encloses the display unit 151, and a touch sensor for sensing a user's touch input is formed at one or more regions of the bezel portion.

Referring to FIG. 14A, when a touch input applied to the bezel portion is received, the controller 180 controls the display unit 151 to output a mark point 308 at an edge region. The controller 180 sequentially outputs a plurality of pre-stored screen information, based on a touch input which moves along the bezel portion.

The controller 180 changes a position of the mark point 308, in correspondence to a position where the touch input is applied. The mark point 308 indicates to which screen information the current screen information corresponds, among the pre-stored plurality of screen information.

Referring to FIGS. 14A(b) and (c) when a long touch input is applied to the bezel portion, the controller 180 moves the mark point 308 in correspondence to a time duration for which the touch input has been input, and controls the display unit 151 to output screen information 300c corresponding to a location region of the mark point 308. If the long touch input is applied, the controller 180 provides aesthetic feeling which seems to provide a plurality of screen information rapidly and sequentially, through an image to turn over pages.

Although not shown, the controller 180 may control the display unit 151 to re-output the already-output background image, based on a touch input applied in an opposite direction to the touch input which moves along the bezel portion.

A control method of changing an output direction of time information will be explained with reference to FIG. 14B.

The bezel portion senses multi touches applied to positions spaced from each other. Upon sensing of the multi touches, the controller 180 rotates the time information, based on a consecutive single touch input.

The watch type terminal 100 according to this embodiment of the present invention can be controlled not only by a touch input sensed by the bezel portion, but also by a touch input applied to an edge of the display unit 151.

Thus, a user can change screen information by applying a touch input, with checking time information.

### INDUSTRIAL APPLICABILITY

The watch type terminal according to embodiments of the present invention provides a control method of changing screen information indicating a current time, according to a user's preference. Thus, the present invention may be applicable to various industrial fields related to the control method.

1. A watch type terminal, comprising:
a body formed to be fixed to a user's wrist;
a display unit mounted to the body, and configured to display current time information;
a memory configured to store therein a plurality of graphic images sorted from one another according to a plurality of contents for indicating the time information; and
a controller configured to control the display unit to output screen information indicating the time information, the screen information including at least one graphic image selected from the plurality of graphic images based on a control command.

2. The watch type terminal of claim 1, wherein the controller controls the display unit to output an edition screen corresponding to an edition mode activated based on an edition control command applied to the display unit,
wherein the edition screen includes:
a selection menu for selecting a plurality of contents; and
an inactive region formed to enclose the edition menu.

3. The watch type terminal of claim 2, wherein the edition menu includes a plurality of menu icons configured to receive a touch input so as to select a first content to be changed, among the plurality of contents.

4. The watch type terminal of claim 3, wherein the display unit outputs an edition image corresponding to the selected first content, and changes the edition image into another image based on a preset type of first touch applied to the edition image.

5. The watch type terminal of claim 4, wherein upon input of a second touch applied to the display unit in a different direction from the first touch, the controller controls the display unit to output a graphic image corresponding to second content among the plurality of contents.

6. The watch type terminal of claim 5, wherein the first touch corresponds to a consecutive touch input applied along the inactive region.

7. The watch type terminal of claim 5, wherein the body further includes a bezel portion configured to support an edge of the display unit, and wherein the controller controls the display unit to sequentially output the plurality of graphic images, based on a touch input applied to the bezel portion.

8. The watch type terminal of claim 4, wherein the display unit outputs the edition image together with the rest contents rather than the first content.

9. The watch type terminal of claim 2, wherein the plurality of contents include a dial portion informing hours, a hands-portion informing a time by indicating the dial portion, and a background image, and wherein the edition control command corresponds to a consecutive touch input applied along the hands-portion.

10. The watch type terminal of claim 2, wherein the controller forms the edition control command by sensing a palm covering the display unit within a specific range.

11. The watch type terminal of claim 6, wherein the controller divides the display unit into a plurality of regions for receiving touch inputs so as to select content to be edited in the edition mode.

12. The watch type terminal of claim 2, wherein the controller activates the edition mode based on a touch input applied to one of the plurality of contents, and wherein the controller controls the display unit to output graphic images corresponding to the plurality of contents in the edition mode.

13. The watch type terminal of claim 1, wherein the plurality of contents include a dial portion having a plurality of dials so as to inform hours, a hands-portion informing a time by indicating the dial portion, and a background image, and
wherein the controller activates an edition mode for editing part of the plurality of dials, based on a touch input which moves along the dial portion.

14. The watch type terminal of claim 11, wherein when a dial to be edited is selected from the plurality of dials, the controller controls the display unit to output a virtual keyboard including a plurality of images.

15. The watch type terminal of claim 1, wherein the plurality of contents include a dial portion including a plurality of dials so as to inform hours, a hands-portion informing a time by indicating the dial portion, and a background image, and
wherein the controller controls the display unit to move the hands-portion and to change the background image, as time lapses.

16. The watch type terminal of claim 1, further including a wireless communication unit configured to receive data on the background image, from outside,
wherein the controller controls the display unit to change the time information based on the data.

17. The watch type terminal of claim 16, wherein the wireless communication unit performs wireless communication with a charging device for charging a power supply unit of the watch type terminal, and
wherein the data includes information on the background image similar to a pattern of appearance of the charging device.

18. The watch type terminal of claim 16, wherein the wireless communication unit is wirelessly connected to a mobile terminal including a display unit, and
wherein the controller controls the wireless communication unit to receive data on a plurality of graphic images output to the display unit of the mobile terminal, the plurality of graphic images corresponding to the plurality of contents.

19. The watch type terminal of claim 18, wherein the controller controls the wireless communication unit to perform wireless communication, when the display unit of the watch type terminal is overlapped with the display unit of the mobile terminal.

20. The watch type terminal of claim 16, wherein the data includes an image captured by the mobile terminal, the image formed as an external environment is patterned.

21. The watch type terminal of claim 1, wherein the controller controls the display unit to output a mode menu screen for selecting a plurality of modes, and
wherein the memory includes data on the plurality of modes, and stores therein data on an information window output to the one region of the display unit.
